(19) United States
(12) Patent Application Publication
(10) Pub. No.: US 2004/0228511 A1
(43) Pub. Date: Nov. 18, 2004

(54) Method and apparatus for setting the contrast and brightness of radiographic images

(76) Inventors: Jean Lienard, Igny (FR); Francois Serge Nicolas, Gig-Sur-Yvette (FR)

Correspondence Address: CANTOR COLBURN, LLP, 55 GRIFFIN ROAD SOUTH, BLOOMFIELD, CT, 06002

(21) Appl. No.: 10/839,849

(22) Filed: May 6, 2004

(30) Foreign Application Priority Data
May 14, 2003 (FR) 03 05773

(51) Int. Cl. H05G 1/64; G06K 9/00

(52) U.S. Cl. 382/132

(57) ABSTRACT

A method and apparatus for improving angiographic images to be used with a radiography device comprising an X-ray source, a device for recording an image and an object positioned so as to present a region of interest to be imaged. The method comprises a) acquisition of a series of successive images of the region of interest; b) determination of a map image from the series of images; c) determination of a set of parameters characterizing a Gaussian distribution function that models the distribution of the grey levels of the map image; d) determination of a brightness and/or contrast improvement function; and e) application of the improvement function to the series of images in a subtractive mode.

### CROSS-REFERENCE TO RELATED APPLICATIONS

This application claims the benefit of a priority under 35 USC 119(a)-(d) to French Patent Application No. 03 05773 filed May 14, 2003, the entire contents of which are hereby incorporated by reference.

### BACKGROUND OF THE INVENTION

An embodiment of this invention relates to a method and apparatus for setting the contrast and brightness of radiographic images. In particular, an embodiment of the invention is directed to subtractive digital angiography, and a radiography apparatus using the method.

Subtractive digital angiography is a known method of acquisition of vascular images in which a radiologist makes an examination of blood vessels using an X-ray radiography apparatus. The vascular morphology and associated function(s) may be revealed by the injection of a contrast agent through a catheter located inside the vessel in which the radiologist is interested. Since the radiologist is primarily interested in the opacified vessel, the rest of the patient's anatomy (muscles, bones, etc.) is subtracted using an image (the mask) obtained by an acquisition made before the contrast product was injected. There are usually a wide variety of intensities in the subtractive digital angiography images produced within the vascular tree thus obtained, as a result of the:

i) considerable diversity of blood vessel dimensions,

ii) disparity of the blood flow within these various vessels,

iii) variable quantity and variable concentration of the injected contrast product, and

iv) different settings of the X-ray radiography device used.

Consequently, the radiologist manually modifies the brightness and the contrast of the image displayed on, for example, a screen, in order to adjust the visibility of a blood vessel of interest and to optimize the diagnostic. This manipulation is relatively difficult and long to carry out.

### BRIEF DESCRIPTION OF THE INVENTION

An embodiment of the invention provides a simple and fast method of automatically presenting an image with a good contrast and/or brightness. An embodiment of the invention is a method and apparatus for improving images to be used with a radiography apparatus of the type comprising means for providing a source of radiation, such as an X-ray source, means for recording the images placed facing the source, means for support placed between the source and the means for recording on which an object, such as a patient, will be positioned so as to present a region of interest to be subject to the radiation, and means for display or storage of the images, the method comprising:

a) acquisition of a series of successive images Iₙ of the region of interest, by the means for recording;

b) determination of a map image I from a series of images Iₙ acquired in this manner;

c) determination of a set of parameters characterizing a mix of Gaussian distributions that model the distribution of the grey levels of the map image I;

d) determination of a brightness and/or contrast improvement function (EXP-LUT), from the various parameters mentioned above; and

e) application of the improvement function to the series of images Iₙ to display the series of images on means for display in a subtractive mode.

### BRIEF DESCRIPTION OF THE DRAWINGS

Other characteristics and advantages of the invention will become clear after reading the following description of a preferred embodiment and the appended drawings in which:

FIG. 1 shows a radiography apparatus that can be used to implement an embodiment of the method;

FIG. 2 is a series of images acquired when a contrast product is injected, used as input data for an embodiment of the method; and

FIG. 3 is an illustration by a series of graphs showing an embodiment of the method.

### DETAILED DESCRIPTION OF THE INVENTION

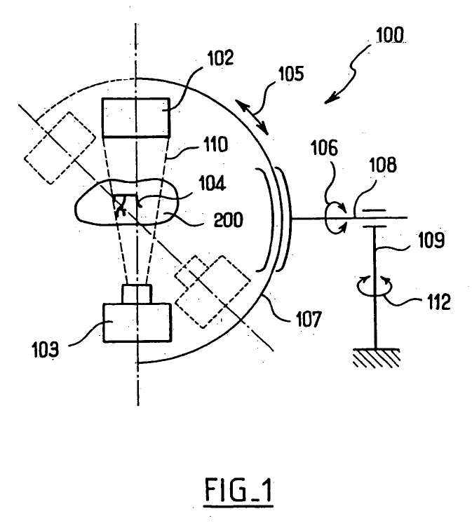

FIG. 1 shows a radiography apparatus 100 that includes means for acquiring images, such as radiography plates 102, and means for providing a source of radiation, such as emitting X-rays 103 in the form of an X-ray source. The means for acquiring images, such as the radiography plates 102, may comprise a plane sensor or a luminescence amplifier associated with a camera. The X-ray source 103 and the means for acquiring images, such as the radiography plates 102, are fixed at each end of a carrier arm 107 acting as a positioner, and are arranged, as an example, around a semi-circle. The semi-circular arm 107 is fixed in a sliding relationship to a second arm 108. The second arm 108 is itself fixed in rotation to a base 109 of the radiography apparatus 100. The base 109 is fixed such that it is free in rotation 112 with respect to a floor.

The arm 108 is capable of applying rotation movements 106 about its own axis. The semi-circular arm 107 is free to slide with respect to the arm 108, such that the semi-circular arm 107 makes a rotation movement 105 with respect to the center of the semi-circle forming the arm 107.

During use, an object to be imaged, such as a body of a patient 200, is placed between the X-ray source 103 and the plates 102 on a support not shown, such that a region of interest 104 of the patient 200 is within the field 110 of the camera.

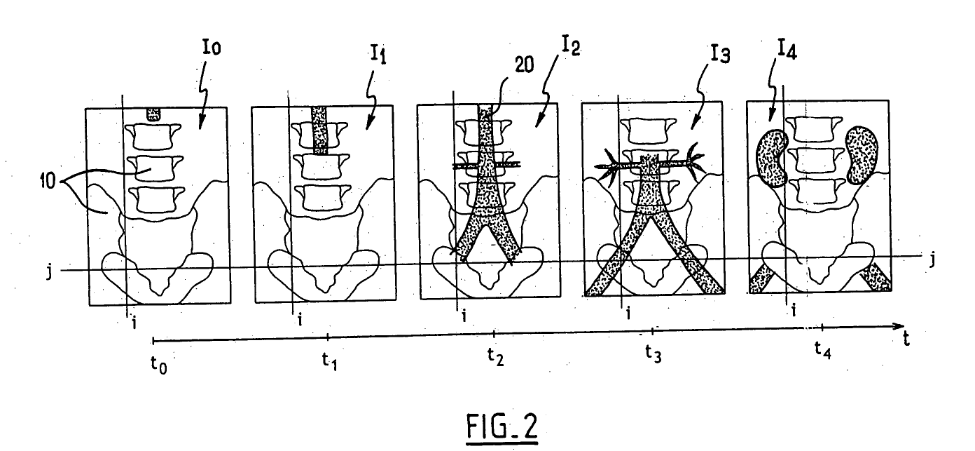

FIG. 2 shows a step in an embodiment of.the method for the acquisition of a series of successive images Iₙ in the region of interest 104 of the patient 200, while a contrast product was injected in the vessels of the region of interest. FIG. 2 shows a set of five successive images numbered I₀ to I₄, that show progression of the contrast product in the blood stream 20 in the region of interest under the action of circulation of the blood in the patient 200. Furthermore, different images in the sequence show a set of so-called. background structures 10 that correspond to all tissues in the region of interest in the patient 200 other than the blood vessels. In the example illustrated in FIG. 2, only the bones have been shown among all the so-called background structures.

A further step determines a first image PO and a mask M. This further step may be done at the same time as the series of successive images described above is acquired. In this case, the series of images is not recorded in the means for image storage of the radiography apparatus. All that will be recorded in the means for storage will be the image PO and the mask M.

The image PO is determined using the maximum opacification principle. Initially, the image PO is initialized with the contents of the first image I₀ in the sequence of previously acquired images. Each point (i, j) in the image Iₙ is then compared with the corresponding points (i, j) in the current image PO, by looping on all the other images Iₙ in the sequence of images. If the intensity of the point considered on the image Iₙ is less than the intensity of its equivalent point on image PO, the point on the image PO is replaced by the current point on image Iₙ. This operation is done for all points making up the image Iₙ and for all images in the series starting from the second image.

The mask M is determined in a manner similar to determination of the image PO. Initially, the mask M is initialized with the first image I₀ of the series of previously acquired images. The intensity of the point (i, j) of the image. Iₙ is then compared with the intensity of the corresponding point (i, j) in mask M, for each subsequent image Iₙ in the series, and the point with the greatest intensity becomes the new point (i, j) of the mask M. As before, this operation is carried out for all points in the image Iₙ and for all images in the series starting from the second image.

Thus, at the end of the further step there is a determination of a so-called maximum opacification image PO presenting blood vessels through which the contrast product passes, and background structures. There is also determination of a mask M called the maximum intensity mask that shows only background structures.

A next step subtracts the image PO from the mask M so as to obtain a map image I showing only the blood vessels through which the contrast product passed when the series of images was acquired. However, the map image I presents a palette of contrasts between the very fine vessels that have low contrast and larger vessels that have a much higher contrast on the image. Furthermore, the map image I has a background noise inherent firstly to acquisition systems, and secondly to methods for calculation of the map image I.

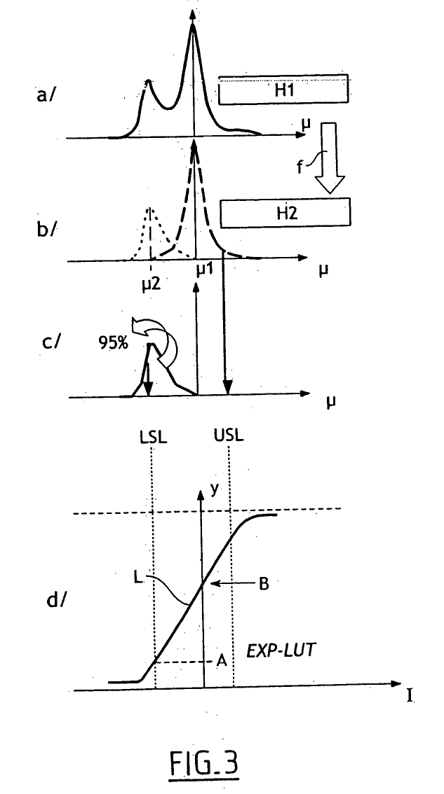

A next step will isolate the blood vessels, the noise and the background of the map image I. This step .is provided by using a complete histogram of the map image I. An example of a complete histogram H1 is illustrated in graph a in FIG. 3. Therefore, there is a multi-mode distribution, in this case illustrated by two modes. This grey level distribution comprises two main .items of information: firstly information concerning vessels through which the contrast product has passed, and secondly information about the background and the noise. This data is used to determine the best match between a probability density function represented by this histogram H1 and a function comprising, for example, of a weighted Gaussian distribution sum in the form

$$f ( x ) = {\sum }_{k} {p}_{k} \cdot N ( {μ}_{k} , {σ}_{k} ) ,$$

where Pₖ is the percentage of the average mode μₖ in the histogram, with standard deviation σₖ. The step to determine the best of the previously mentioned matches can be done by applying a known deviation maximization (EM) approach. An example of this approach is described by A. P. Dempster, N. M. Lairol and D. B. Rubin, “Maximum likelihood for incomplete data via the EM algorithm”, Journal of the Royal Statistical Society, B39, 1-38 1978, and by C. Liu and D. X. Sun, “Acceleration of EM algorithm for mixture models using ECME”, American Statistical Association Proceeding of the Statistical Computing Section, 109-114, 1997.

During this step a determination is made of all triplets (pₖ, μₖ, σₖ) necessary for find the best match described above, knowing that the sum of the values of pₖ is equal to 1. In an example, as illustrated in FIG. 3, will supply two triplets, one to characterize the noise (k=1), and the other to characterize the contrast product (k=2). When this method is used, μ₁ is equal to about 0 and μ₂ is less than 0.

Once the triplets have been determined, calculate two values called the high specification limit (USL) and the low specification limit (LSL). The LSL value is determined at the point at which the cumulative distribution function of the contrast product reaches 5% (in other words, 95% of all values are beyond this point) as illustrated in FIG. 3c, in other words LSL=μ₂−(1.647×σ₂). Similarly, the USL value is determined at the point at which the cumulative noise distribution function becomes greater than 95% (in other words there are only 5% of values beyond this point); which means that USL=μ₁−(1.645×σ₁). Thus, we obtain the smallest value and then the largest value of a conversion function also called an expansion improvement function (EXP-LUT). This type of conversion function is illustrated in FIG. 3d, and is in the form of a curve with a linear part L for which the limits are represented by the LSL and USL values. The position of this EXP-LUT curve along. the Y axis may be obtained by fixing the output value of the zero input level (point B) that determines the global brightness of the image to be displayed.

In the subtractive digital angiography acquisition mode, the subtractive image is usually transformed into an improved image called the positive image using the EXP-LUT improvement function, the function of which is to adapt the dynamic range of the image (limited by LSL and USL) using grey levels of the display unit (usually coded on 8 bits, to give 256 shades of grey). However, from the user's point of view, contrast relations transformed by the EXP-LUT improvement function must be preserved. Consequently, this requires that a blood vessel filled with a high concentration of the contrast product must not be too dark, so as to enable some transparency and visibility of vascular branches that are covered by or connected to these large blood vessels. On the other hand, thin vessels filled with a low concentration of contrast product must remain visible at all times. These constraints can be satisfied by using an EXP-LUT improvement function that is represented by a light transformation located in the largest grey levels distribution interval.

Before applying the EXP-LUT improvement function, the map image I obtained by the disclosed steps is mainly negative in the opacified regions. Furthermore, the map image I also contain a combination of noise from the mask M and noise from the image PO centered around the zero level. The linear part of the EXP-LUT improvement function should then cover a relatively wide interval of negative contrast intensities so as to satisfy constraints for consistency of the contrast described above. The same linear part of the EXP-LUT improvement function should also cover a variable sized interval of positive grey levels of noise so as to avoid any distortion in the displayed grey levels. The LSL and USL values are automatically determined and form the limits of the linear part of the improvement function EXP-LUT by calculating a set of triplets (pₖ, μₖ, σₖ) as described above.

A variant embodiment of the method fixes the grey level A corresponding to transformation of the LSL value by the EXP-LUT improvement function to an assignable grey level that can be initialized by the user.

In general, histograms illustrating the distribution of grey levels in a map image comprise a modal distribution with n modes, where n is greater than 2. Generalization to determine triplets defining parameters for the Gaussian distribution function that best matches the histogram of the map image comprises initializing the first triplet (p₁, μ₁, σ₁) with μ₁ equal to approximately zero, and characterizing the noise. Initially, there is an assumption that there are, for example, three modes close to the averages μ₁, μ₂ and μ₃. The assumption initializes the value μ₃ of the third triplet to the level of the peak with the smallest value of μ on the histogram. μ₂ is then initialized to be half-way between the value of μ₁ and μ₃. The other values of the triplets p₁, p₂ and p₃ and σ₁, σ₂ and σ₃ are initialized with the same value, for example, by knowing that the sum of the pᵢ values must be equal to 1. Consequently, and iteratively, the different values of the triplets will be modified so as to minimize the error between the Gaussian distribution function associated with the triplets and the probability density function of the histogram of the map image. If the minimum error found is greater than a predetermined threshold, the algorithm repeats the complete iteration by adding an additional triplet to the set of triplets. The algorithm repeats all these steps until the resulting error is less than or equal to the predetermined threshold. The result is then a set of n triplets (pᵢ, μᵢ, σᵢ) modeling the histogram of grey levels characteristic of the map image to be improved. The value of LSL and USL is then calculated as described previously.

Further variant embodiments can make use of additional system information so as to improve determination of the EXP-LUT improvement function, such as the concentration and nature of the injected contrast product (iodine or CO₂), the radiological parameters of the radiography apparatus (kV, mA, exposure time, spectral filter) which has an impact on the contrast of the blood vessels and the noise, the patient equivalent thickness (EPT) determined during the work, and the contrast/noise ratio (CNR) of the target.

Once the improvement function EXP-LUT has been determined, it can be applied on images different from the images on which it was calculated.

An embodiment comprises at least one of the following characteristics:

Step b can include the following sub-steps:

b1) determination of an image PO representing the so-called background structures and blood vessels in the region of interest from the series of images Iₙ, thus acquired, and a mask M showing only the so-called background structures;

b2) determination of the map image I by combining the image PO and the mask M.

The map image I is determined by a formula of the type I=log(PO)−log (M) similar to the logarithmic subtraction used in subtractive digital angiography.

Step c can include steps or sub-steps as follows:

c1) determination of a histogram (H1) representing the distribution of the grey levels of the map image I;

c2) determination of all parameters in the Gaussian distribution function for modeling the histogram (H1);

the Gaussian distribution function is a weighted sum of the said Gaussian distributions;

sub-step C2 comprises determining all parameters such that an error characterizing the difference between the Gaussian distribution function to be determined and the histogram H1 is less than a threshold value, wherein the determination includes the following sub-steps:

initialization of a first set of parameters characterizing the Gaussian distribution function to predetermined values;

iteratively modifying the values of the first set of parameters so as to minimize the error between the Gaussian distribution function and the histogram H1;

if the resulting error is greater than the threshold value, addition of a pre-defined number of parameters to the first set of parameters and repeat the previous step with the new set of parameters and

the previous two steps are repeated until the error obtained is less than or equal to the threshold value.

Step d can include a step for determination of the lower limit (LSL) and the upper limit (USL) of a linear part of the improvement function (EXP-LUT).

One skilled in the art may make or propose various modifications in the function and/or way and/or result and/or structure and/or steps of the disclosed embodiments and equivalents thereof without departing from the scope and extant of the invention.

What is claimed is:

1. An imaging method to be used with a radiography apparatus comprising means for providing a source of radiation, means for recording placed facing the source, and an object placed between the means for providing a source and the means for recording means positioned so as to present a region of interest to be imaged comprising:
a) acquisition of a series of successive images of the region of interest, by the means for recording;
b) determination of a map image from a series of images acquired in this manner;
c) determination of a set of parameters characterizing a Gaussian distribution function that models the distribution of grey levels in the map image I;
d) determination of a brightness and/or contrast improvement function, from the various parameters mentioned above; and
e) application of the improvement function to the series of images to display the series of images in a subtractive mode.

2. The method according to claim 1 wherein step c includes sub-steps as follows:
c1) determination of a histogram representing the distribution of grey levels in the map image I; and
c2) determination of all parameters in the Gaussian distribution function for modeling the histogram.

3. The method according to claim 1 wherein the Gaussian distribution function is a weighted sum of the Gaussian distributions.

4. The method according to claim 2 wherein the Gaussian distribution function is a weighted sum of the Gaussian distributions.

5. The method according to claim 3 wherein sub-step c2) comprises determining all parameters such that an error characterizing the difference between the Gaussian distribution function to be determined and a histogram is less than a threshold value.

6. The method according to claim 4 wherein sub-step c2) comprises determining all parameters such that an error characterizing the difference between the Gaussian distribution function to be determined and a histogram is less than a threshold value.

7. The method according to claim 4 wherein the determination includes the following sub-steps:
initialization of a first set of parameters characterizing the Gaussian distribution function to pre-determined values;
iteratively modifying the values of the first set of parameters so as to minimize the error between the Gaussian distribution function and the histogram;
if the resulting error is greater than the threshold value, addition of a pre-defined number of parameters to the first set of parameters and repeat the previous step with the new set of parameters; and
the previous two steps are repeated until the error obtained is less than or equal to the threshold value.

8. The method according to claim 6 wherein the determination includes the following sub-steps:
initialization of a first set of parameters characterizing the Gaussian distribution function to pre-determined values;
iteratively modifying the values of the first set of parameters so as to minimize the error between the Gaussian distribution function and the histogram;
if the resulting error is greater than the threshold value, addition of a pre-defined number of parameters to the first set of parameters and repeat the previous step with the new set of parameters; and
the previous two steps are repeated until the error obtained is less than or equal to the threshold value.

9. The method according to claim 1 wherein step d includes a step for determination of a lower limit and an upper limit of a linear part of the improvement function.

10. The method according to claim 2 wherein step d includes a step for determination of a lower limit and an upper limit of a linear part of the improvement function.

11. The method according to claim 3 wherein step d includes a step for determination of a lower limit and an upper limit of a linear part of the improvement function.

12. The method according to claim 4 wherein step d includes a step for determination of a lower limit and an upper limit of a linear part of the improvement function.

13. The method according to claim 5 wherein step d includes a step for determination of a lower limit and an upper limit of a linear part of the improvement function.

14. The method according to claim 6 wherein step d includes a step for determination of a lower limit and an upper limit of a linear part of the improvement function.

15. The method according to claim 7 wherein step d includes a step for determination of a lower limit and an upper limit of a linear part of the improvement function.

16. The method according to claim 8 wherein step d includes a step for determination of a lower limit and an upper limit of a linear part of the improvement function.

17. The method according to claim 1 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

18. The method according to claim 2 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

19. The method according to claim 3 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

20. The method according to claim 4 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

21. The method according to claim 5 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

22. The method according to claim 6 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

23. The method according to claim 7 wherein step b includes the following sub-steps:
b1) determination of an image representing the so-called background structures and blood vessels in, the region of interest from the series of images thus acquired, and a mask showing only the so-called background structures; and
b2) determination of the map image by combining the image and the mask

24. The method according to claim 8 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

25. The method according to claim 9 wherein step b includes the following sub-steps:
b1) determination of an image representing the so-called background structures and blood vessels in the region of interest from the series of images thus acquired, and a mask showing only the so-called background structures; and
b2) determination of the map image by combining the image and the mask

26. The method according to claim 17 wherein the map image I is determined by a formula of the type I=log (PO)−log (M).

27. The method according to claim 18 wherein the map image I is determined by a formula of the type I=log (PO)−log (M).

28. The method according to claim 19 wherein the map image I is determined by a formula of the type I=log (PO)−log (M).

29. The method according to claim 20 wherein the map image I is determined by a formula of the type I=log (PO)−log (M).

30. The method according to claim 21 wherein the map image I is determined by a formula of the type I=log (PO)−log (M).

31. The method according to claim 22 wherein the map image I is determined by a formula of the type I=log (PO)−log (M).

32. The method according to claim 23 wherein the map image I is determined by a formula of the type I=log (PO)−log (M).

33. The method according to claim 24 wherein the map image I is determined by a formula of the type I=log (PO)−log (M).

34. The method according to claim 25 wherein the map image I is determined by a formula of the type I=log (PO)−log (M).

35. A radiography apparatus comprising:
means for providing a source of radiation;
means for recording placed facing the source;
an object placed between the means for providing a source and the means for recording means positioned so as to present a region of interest to be imaged; and
means for implementing a method according to claim 1.

36. A computer apparatus comprising means for carrying out the method of claim 1.

37. A computer program comprising code means that when executed on a computer carry out the method of claim 1.

38. A computer program on a carrier carrying code that when executed on a computer carry out the method of claim 1.

39. A method of operating a data processing system comprising:
a) acquisition of a series of successive images of a region of interest of an object to be imaged;
b) determination of a map image from a series of images acquired in this manner;
d) determination of a set of parameters characterizing a Gaussian distribution function that models the distribution of grey levels in the map image;
d) determination of a brightness and/or contrast improvement function, from the various parameters mentioned above; and
e) application of the improvement function to the series of images to display the series of images in a subtractive mode.
